(19) United States
(12) Patent Application Publication
(10) Pub. No.: US 2009/0252161 A1
(43) Pub. Date: Oct. 8, 2009

(54) Method And Systems For Routing A Data Packet Based On Geospatial Information

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/062,101

(22) Filed: Apr. 3, 2008

(51) Int. Cl. H04L 12/56

(52) U.S. Cl. 370/389

(57) ABSTRACT

Methods and systems are described for routing a data packet based on geospatial information. In one aspect, a data packet is received, at a receiving network node. The data packet was transmitted by a source host for transmitting to a destination host. Further, a level of trust for a portion of a network path from the source host to the destination host is determined. The portion of the network path has a geospatial region. The level of trust is based on trust information associated with the geospatial region. Also, routing information is determined based on the level of trust. Further, a network interface of the receiving network node for transmitting the data packet via a destination network path is identified based on the routing information. Still further, the data packet is routed via the identified network interface.

### BACKGROUND

In today's computer systems sensitive data is sent over networks. The sensitive data needs to be protected. Today's methods for protecting this data include encrypting the data, encrypting the connection as performed by virtual private networks (VPN), or by sending the data via a private network avoiding possibly malicious network nodes on the Internet and other public networks.

Additionally, a great deal of spam and malicious software originates from computers in known regions of the world. In these regions governments in authority typically take little action to prevent these activities. These regions are known to be troublesome with regard to spam and malicious software. Techniques such as policy-based routing can be used to avoid specific network nodes and subnets or even to block traffic from specific nodes and subnets. The relationship between network addresses and geospatial regions, however, is not apparent to network nodes relaying data packets based on the network addresses.

### SUMMARY

A method and systems are described for routing a data packet based on geospatial information. In one aspect, a method for routing a data packet based on geospatial information is described. The method includes receiving a data packet at a receiving network node. The data packet is transmitted by a source host for transmitting to a destination host. Further, the method includes determining a level of trust for a portion of a network path from the source host to the destination host. The portion of the network path has a geospatial region. The level of trust is based on the geospatial region. Also, the method includes determining routing information based on the level of trust. Further, the method includes identifying a network interface of the receiving network node for transmitting the data packet via a destination network path based on the routing information. Still further, the method includes routing the data packet via the identified network interface.

According to another aspect, a system for routing a data packet based on geospatial information is described. The system includes a network interface component configured for receiving, at a receiving network node, a data packet transmitted by a source host for transmitting to a destination host. The system also includes a general processing unit component configured for determining a level of trust for a portion of a network path from the source host to the destination host. The portion of the network path has a geospatial region and the level of trust is based on the geospatial region. The system further includes a routing engine component configured for determining routing information based on the level of trust. The system still further includes a forwarding engine component configured for identifying a network interface of the receiving network node for transmitting the data packet via a destination network path based on the routing information. The system also includes a line card component configured for routing the data packet via the identified network interface.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for routing a data packet based on geospatial information according to an embodiment of the subject matter described herein;

FIG. 2 is a block diagram illustrating a system for routing a data packet based on geospatial information according to another embodiment of the subject matter described herein;

FIG. 3 is a block diagram illustrating an arrangement of components for routing a data packet based on geospatial information according to another embodiment of the subject matter described herein; and

FIG. 4 is block a diagram illustrating an arrangement of components for routing a data packet based on geospatial information according to another embodiment of the subject matter described herein.

### DETAILED DESCRIPTION

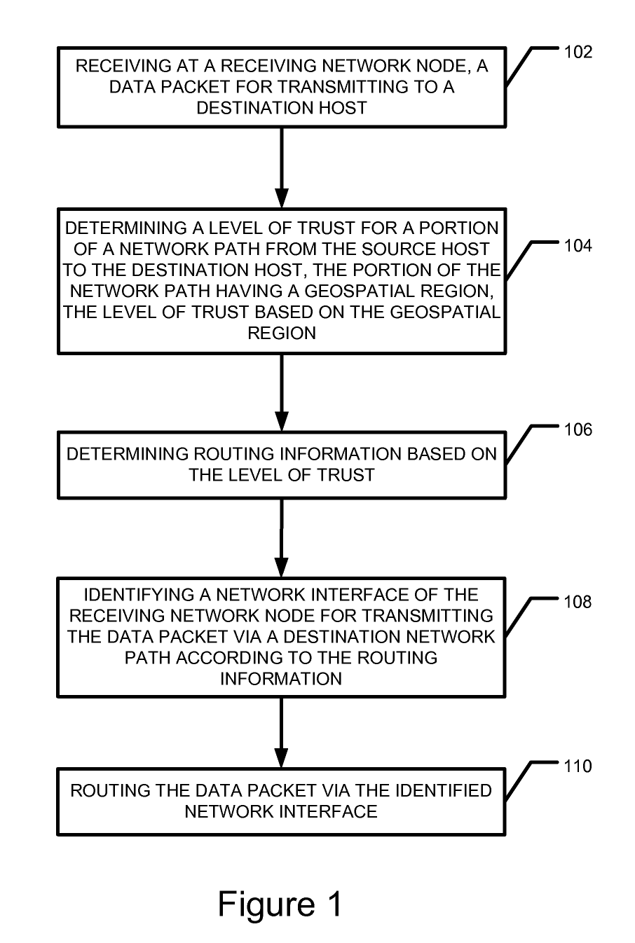

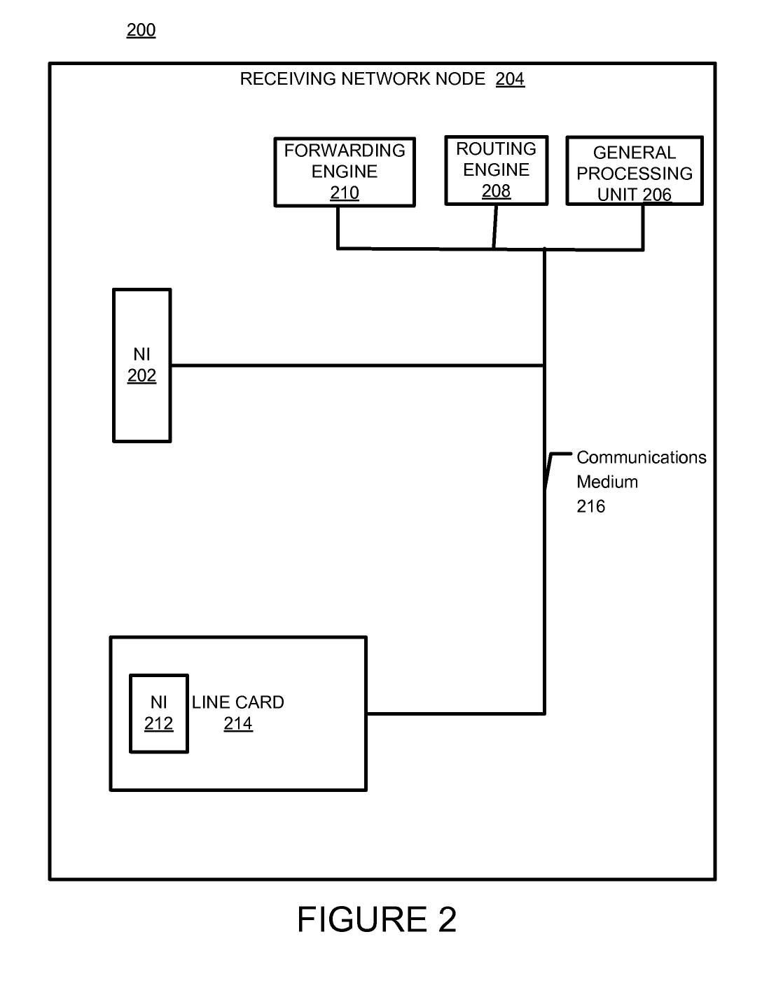

FIG. 1 is a flow diagram illustrating a method for routing a data packet based on geospatial information according to an exemplary embodiment of the subject matter described herein. FIG. 2 is a block diagram illustrating a system for routing a data packet based on geospatial information according to another exemplary embodiment of the subject matter described herein. The method illustrated in FIG. 1 can be carried out by, for example, some or all of the components illustrated in the exemplary system of FIG. 2.

With reference to FIG. 1, in block 102 a data packet is received, at a receiving network node. The data packet is transmitted by a source host for transmitting to a destination host. Accordingly, a system for routing a data packet based on geospatial information includes means for receiving a data packet transmitted by a source host for transmitting to a destination host. For example, as illustrated in FIG. 2, a network interface component 202 is configured for receiving, at a receiving network node 204, a data packet transmitted by a source host for transmitting to a destination host.

A data packet can be received in a variety of forms. For example, a received data packet can be modified by providing a packet header, for example, prior to transmitting the packet. Additionally, several received data packets can be combined into a single data packet for transmitting, and a single data packet can be split into several packets for transmitting. Also, a data packet formatted according to a first protocol can be converted to one or more data packets formatted in a second protocol. Further, a data packet can be encapsulated in another data packet when received and the encapsulated data packets can be transmitted unencapsulated, and vice versa. For ease of description, the term data packet is used herein to refer the various data packets in the forms described and to forms not mentioned, such as where a data packet includes a common piece of a message payload. For example, a single received data packet can be transmitted as two data packets as the data traverses a network path. The single received data packet and the two transmitted data packets are referred to as a data packet herein.

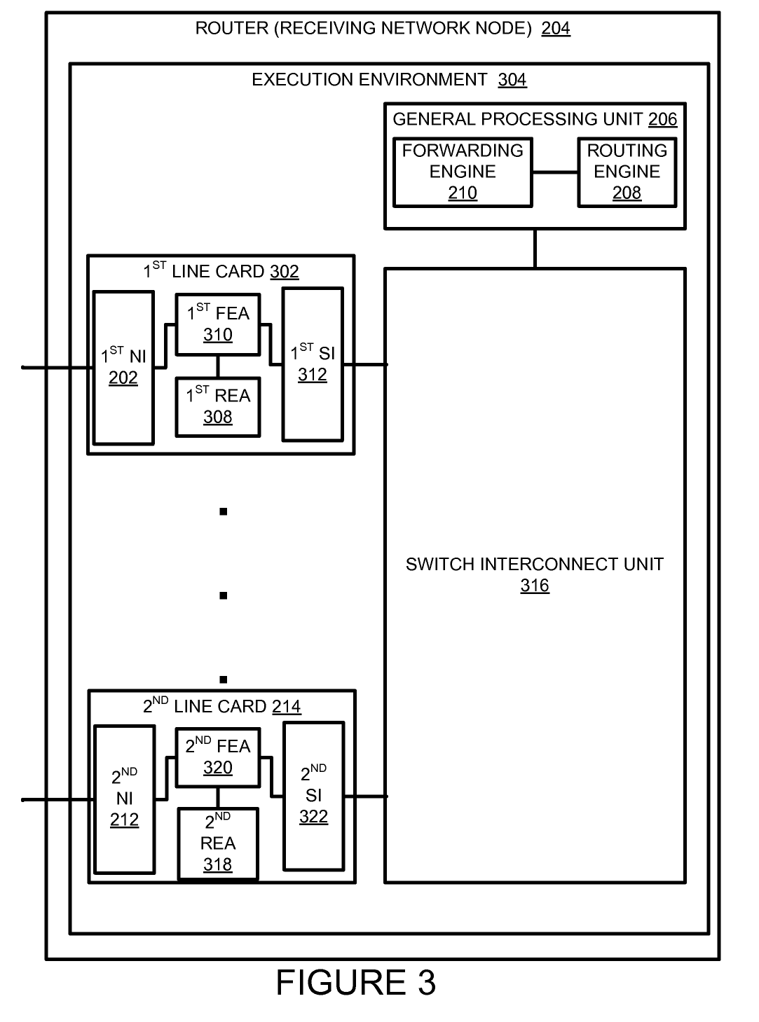

For example, as illustrated in FIG. 2, the network interface (NI) 202 is included in the receiving network node 204. As illustrated in FIG. 3, the network interface 202 can be a first network interface 202, included in a first line card 302 of the receiving network node 204, illustrated as a router in FIG. 3. The first network interface 202 can be operatively coupled to a network for receiving the data packet for transmitting to a destination host. FIG. 3 illustrates an exemplary arrangement of components providing an execution environment 304 configured for hosting the components in the receiving network node 204 illustrated in FIG. 2. Alternatively, a network interface can be a network interface application program interface (API). SOCKETS is an exemplary network interface API. SOCKETS is an API configured for receiving a data packet for transmitting to a destination host. Thus, a receiving network node can be a source host including a network interface API for receiving a data packet for transmitting to a destination, and a receiving network node can be any intermediate network node included in a network path traversed by the data packet from the source host to a destination host.

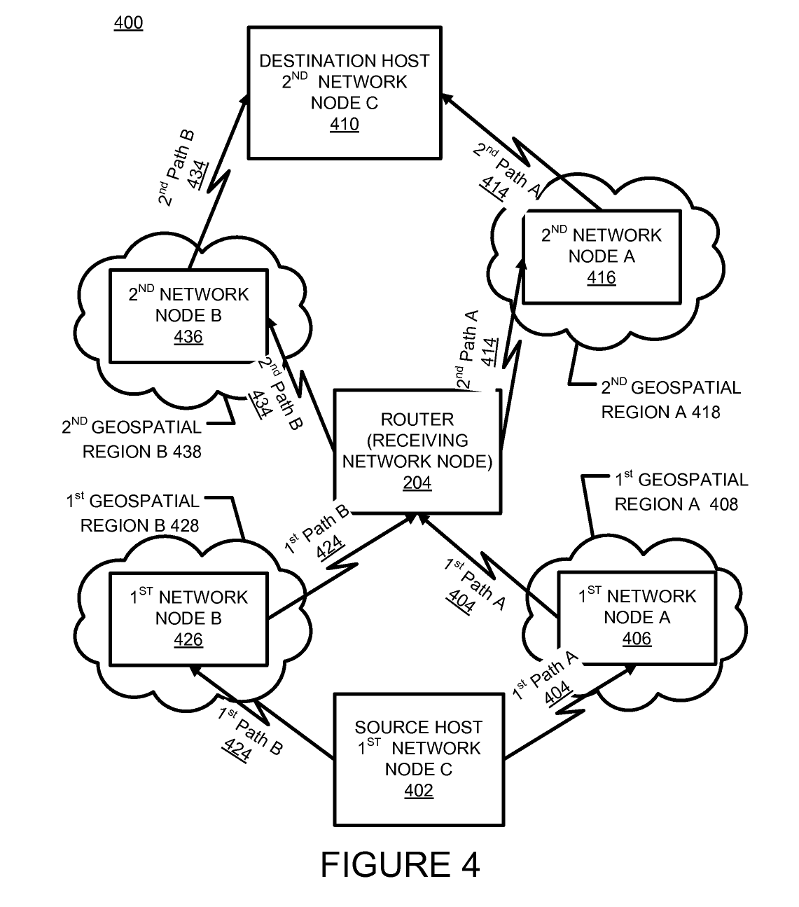

FIG. 4 depicts an exemplary network 400 including the receiving network node 204. The first network interface 202 can be operatively coupled to a portion of the network including a source host 402. The first network interface 202 can receive the data packet transmitted from the source host 402 via a network path included in the network. One or more network paths can exist for transmitting the data packet. For example, the first network interface 202 in the receiving network node 204 can receive the data packet via a first network path A 404 including a first network node A 406. Alternatively or additionally, the data packet can be received via other network paths and other network interfaces of the receiving network node 204 when one exists between the receiving network node 204 and the source host 402. An alternative exemplary first network path B 424 is illustrated in FIG. 4. The first network path B 424 includes a first network node B 426 as a network node in the network path that the data packet can traverse from the source host 402 to the receiving network node 204.

In FIG. 3, the first network interface 202 is illustrated as included in the first line card 302. A line card can be a network interface card (NIC) that transfers the packet to an application for transmitting the packet via a destination path to a destination host. The NIC can be included in a desktop PC, a notebook, a server, or a handheld computing device serving as a gateway, bridge, or other network relay device. Further, the first line card 302 can also include more advanced function for managing more data packets as is described below.

Arrangements for performing the method illustrated in FIG. 1 can be adapted for operating in execution environments of a variety of network node types in the role of a receiving network node. In addition to end user devices and routers as described above, a receiving network node can be any network node configured for hosting any arrangement of components for performing the method illustrated in FIG. 1. For example, the receiving network node can be any of (a non-exhaustive list) a gateway, a switch, a virtual private network (VPN) concentrator, a modem, a wireless access point (WAP), a bridge, a hub, a repeater, a firewall, a proxy server, an application for relaying data packets, and a source host for initiating the transmission of content of a data packet content.

The receiving network node 204 can be configured for receiving and for transmitting a data packet to a destination host at any protocol layer of the network 400. For example, a receiving network node can receive and transmit a data packet at a link layer as performed by an Ethernet bridge and a multiple protocol labeling switch (MPLS). Further, a receiving network node can receive and transmit a data packet at a network layer as performed by an Internet protocol (IP) router. Further, a receiving network node can receive and transmit a data packet at a transport layer as performed by a proxy for relaying a packet from a first TCP connection to a second TCP connection. Further, a receiving network node can receive and transmit a data packet at a session layer as performed by a hypertext transmission protocol (HTTP) proxy for relaying an HTTP message associated with session information from a first HTTP connection to a second HTTP connection. Further, a receiving network node can receive and transmit a data packet at a presentation layer, an application layer, a physical layer as performed by a repeater, across protocol layers as performed by a protocol gateway, and across layers as performed by a protocol tunneling service.

As described above, the receiving network node 204 can be configured for receiving and for transmitting a data packet to a destination host at any protocol layer. Accordingly, a data packet can be a physical layer data packet, a link layer data packet, a network layer data packet, a transport layer data packet, a session data layer packet, a presentation data layer packet, and/or an application layer data packet a given point in a network path traversed by the data packet.

Further, at each of the protocol layers, a variety of applications can host the arrangement illustrated in FIG. 2. For example, at the application layer, hosting applications can include a messaging application such as an email application and/or an instant messaging application; a subscription application such as a presence application; and a web application. As used herein, the term application can refer to a client application, a server application, a peer application, and distributed application components.

Returning to FIG. 1, in block 104 a level of trust is determined for a portion of a network path from the source host to the destination host. The portion of the network path has an associated geospatial region. The level of trust is based on the trust information associated with the geospatial region. Accordingly, a system for routing a data packet based on geospatial information includes means for determining a level of trust for a portion of a network path from the source host to the destination host, the portion of the network path having a geospatial region, the level of trust based on trust information associated with the geospatial region. For example, as illustrated in FIG. 2, a general processing unit component 206 is configured for determining a level of trust for a portion of a network path from the source host to the destination host, the portion of the network path having a geospatial region, the level of trust based on trust information associated with the geospatial region.

A level of trust can be based on trust information. Trust information can be received via a user interface, a configuration data store, and/or via a message received from another network node. Trust information can be for specifying a policy, evaluating a policy, and/or for generating and maintaining a routing table. Trust information can be received by the general processing unit 206. For example, trust information can be received in a message, such as a message from a directory service such as a domain name service (DNS). For example, the receiving network node 204 can send a query to the DNS system for retrieving geospatial information associated with a network address of a network node stored in a LOC record. The network node can be included in a network path to a destination host. A level of trust can be determined based on geospatial information received in a response from the DNS system to the query.

The message including trust information can be and/or can include the data packet. For example, the data packet can include routing information that identifies network addresses of a portion of a network path from the source host to the destination host, such as a route traversed and/or a route allowing the data packet to be transmitted to a destination host. For example, an IP packet routed using source routing can include routing information. Further, trust information can identify a network interface of a network node included in the portion of the network path. The identifier can be a network address and/or a host name included in the packet as a geospatial identifier and/or can be an identifier from which geospatial information can be determined.

Trust information can include a level of trust and/or geospatial information for determining a level of trust. For example, the trust information included in the received data packet can include a level of trust. For example, a level of trust can be included in a certificate and/or a signature associated with a network node included in the portion of the network path. The certificate and/or the signature can be signed or otherwise verified by a third-party. The third-party can be associated with a level of trust by the receiving network node 204. Accordingly, the general processing unit component 206 can determine a level of trust by receiving trust information including the level of trust in the certificate and/or the signature.

For example, the general processing unit 206 can communicate with a routing engine 208. In another aspect illustrated in FIG. 3, the general processing unit 206 can include the routing engine 208. The routing engine 208 is configured for managing one or more policies and/or is configured for managing one or more routing tables. A routing table can be generated and updated based on one or more metrics associated with routes in a network. Examples of metrics currently in use include path length, reliability such as a metric based on dropped packets, delay, and bandwidth. A metric can consist of any value that can be used to determine whether a route in a network should perform better than another route in the network. For example, a routing algorithm can use the metric in determining whether a route in a network should perform better than another route in the network. A level of trust can be expressed as a level of trust metric. Trust information can include a level of trust metric and/or geospatial information for determining a level of trust metric.

A number of routing protocols exist for providing a trust metric indicating a level of trust associated with the portion of the network path to the destination host. For example, the portion of the path can be associated with the region via an association between the region and a network node in the portion of the path. A portion of the network path can include the entire path from the source host to the destination host or any portion of that path. The portion of the network path can be a single node, multiple nodes, a cable connecting two nodes, or any combination thereof. Accordingly, the level of trust can be associated with a region without there being a node in the region. Alternatively, the portion of the network path can be a single node wherein the geospatial region of that node is the geospatial region of the portion of the network path. A network node in the portion of the network path can be associated with a geospatial region identified by geospatial information where the trust metric is associated with the geospatial region. As illustrated in FIG. 4, the first network path A 404 is associated with a first geospatial region A 408 and the second network path A 414 is associated with a second geospatial region A 418. Similarly, trust information associated with a portion of a network path for policy specification and/or evaluation can be received via a message from any network node in the network 400.

Various protocols are suitable for providing trust information for policy evaluation and/or a level of trust metric for generating and updating a routing table. For example, link state protocols such as the Open Shortest Path First (OSPF), distance vector protocols such as the Routing Information Protocol (RIP), path vector protocols such as the Border Gateway Protocol (BGP), and label switching protocols such as Multi-protocol Label Switching (MPLS) can be used. Both OSPF and RIP message formats support a message area for one or more metrics. A metric indicating the level of trust associated with a network node, such as a router, can be included along with other optional metrics. The exchange of level of trust metrics allows a receiving network node to identify a level of trust associated with a portion of a network path to a destination host. BGP allows a network node to advertise paths to reach a destination. A network node, having such information, can apply one or more policies associated with one or more network nodes included in the portion of the network path.

A policy can take trust information received by the network node as described above as input for evaluating the policy. Further, a policy can take geospatial information and optionally other information associated with a network node in a network path for identifying a level of trust as a result of evaluating the policy. For example, the routing may also be based on the size of the packet, the protocol of the payload, or some other characteristic. It can also be based on a combination of characteristics. In MPLS, labels (and thus routes) are determined by a packet's forwarding equivalence class (FEC). A FEC can be defined based on a level of trust associated with a network node in a network path to a destination. The level of trust can be associated with a geospatial region associated with the network node and identified by geospatial information.

In another aspect, the portion of the network path from the source host to the destination host includes a path network node. The level of trust can be based on a geospatial region associated with the path network node. In the network 400 illustrated in FIG. 4, a path network node is included in a network path associated with the received data packet. A data packet can be associated with any path network node in any portion of a network path traversed by the packet from the source host 402 to the destination host 410. FIG. 4 illustrates an aspect wherein the receiving network node 204 is a path network node included in the network path associated with the data packet. When the receiving network node 204 is included in the portion of the network path, a level of trust can be associated with the receiving network node 204 and with geospatial information identifying a geospatial region (not shown) associated with the receiving network node 204.

The portion of a network path from the source host to the destination host can include a first network path, including a first network node, traversed by the data packet, and/or a second network path, including a second network node, allowing the data packet to be transmitted to the destination host. The first network node can be a source host that initiates the transmission of the data packet over a network path in a network. In FIG. 4, a level of trust associated with the source host 402, also labeled first network node C, can be determined by the general processing unit 206 in the receiving network node 204. The level of trust can be associated with geospatial information identifying a geospatial region associated with the source host 402. The second network node can be a destination host. In FIG. 4, a level of trust associated with the destination host 410 can be determined by the general processing unit 206. The level of trust can be associated with geospatial information identifying a geospatial region associated with the destination host 410.

The data packet can be transmitted by the source host 402. As described above, a data packet can be associated with a portion of a network path that can be a first network path traversed by the data packet and/or a second network path allowing the data packet to be transmitted to the destination host from the receiving network node. The destination host is considered to be included in the network path. For example, the data packet is associated with a first network path A 404 including the first network node A 406 when the data packet traverses the first network path A 404 to the receiving network node router 204, for receiving by the first network interface 202. The first network node A 406 is illustrated having a first geospatial region A 408. With respect to the second network path, the data packet is associated with a second network path A 414 including a second network node A 416 in that the data packet can traverse the second network path A 404 from the receiving network node 204 to the destination hot 410. The second network node A 406 is illustrated having a second geospatial region A 408. Any portion of a second network path actually traversed from the receiving network node 204 to the destination host 410 is a destination path.

The general processing unit 206 can be configured for receiving trust information for identifying a level of trust associated with the first network node A 406 and/or the second network node A 416 when the packet is received via the first path A 404. When geospatial information is received, a level of trust can be determined by the general processing unit 206 based on the geospatial information. When the data packet traverses the first network path A 404, the general processing unit 206 is configured for identifying a level of trust associated with one or more networks nodes in the first network path A 404 and their respective geospatial regions such as the first network node A 406 and the first geospatial region 408. Alternatively or additionally, when it is determined that the data packet can reach the destination host 410 by traversing the second network path A 414, the general processing unit 206 can be configured for identifying a level of trust associated with one or more network nodes and their respective geospatial regions in the second network path A 414, such as the second network node A 416 and the second geospatial region 418. In the network 400, an additional network path to the destination host 410 is illustrated as a second network path B 434 including a second network node B 426. A second geospatial region B 438 is associated with the second network node B 436. The general processing unit 206 can receive trust information identifying a level of trust associated with the second network node B 436. Trust information identifying a level of trust can be received via a configuration interface and/or via a message from one or more network nodes in the network 400 including the receiving network node, the router 204.

An association between a portion of a network path from the source host to the destination host and a geospatial region can be based on a variety of factors. A network node included in the portion of a network path from the source host to the destination host can be associated a geospatial region based on factors including a distance, an owner entity, a government entity, an administrative entity, a certification entity, a history, an agreement, a social relationship, a measure of reliability, a geospatial attribute, a measure of cost, a measure of network performance, and a time.

For example, a level of trust can be determined based on a distance between a network node included in a portion of the network path and a geospatial region. The level of trust can vary inversely with the distance, so that a network node is most trusted when it is included in a particular geospatial region, or vice versa. A level of trust can be based on a relationship between owners of a receiving network node and a network node. For example, a high level of trust can be associated with a receiving network node and a network node that have a common owner. A level of trust can be determined based on information associated with a government entity with authority of a geospatial region that includes a network node. Levels of trust can be assigned for specific government entities from which a level of trust can be determined or assigned for a network node associated with a geospatial region under control of a particular government entity. An administrative entity for administering a network node, or with administrative authority over a geospatial region associated with a network node, can identify or be used for determining a level of trust associated with the geospatial region and the network node. A level of trust can be assigned to a network node associated with a geospatial region by a certification entity.

A level of trust can be associated with a portion of a network path having a geospatial region based on a past event or lack of a past event. For example, a portion of a network path having a geospatial region including or being known to include network sniffing device can be associated with a relatively lower level of trust than a geospatial region including a network and network nodes without any known current or past history of included sniffing devices.

Further a level of trust can be associated with portion of a network path having a geospatial region based on an agreement made by an entity associated with the network node and the region. For example, as described above, a government entity with control over a geospatial region including a network node can be a signatory to an agreement for ensuring a network included in the geospatial region meets a specified security requirement. An agreement can be a contract and/or an informal agreement between entities associated with a receiving network node and a network node. Further, a level of trust can be associated with a quality of service (QOS) provided by a portion of a network in a geospatial region including a network node. The provider can charge prices based on the level of trust required. A level of trust associated with a geospatial region including a network node can vary with time. For example, a subnet including the second network node B 436 in the second geospatial region B 438 can have a higher level of trust at certain hours of the day or certain times of the year.

The receiving network node 204 can update a level of trust maintained for it based on a level of trust associated with another network node in the network 400. The receiving network node 204 can send a message to another network node in the network 400 for altering a level of trust associated with the other network node and its associated region. Still further, the receiving network node 204 can send a message to a network node for altering the level of trust the network node associates with still another network node in the network. The updates/alterations can be based on interaction of the receiving network node with other network nodes in the network and/or can be based on user provided data.

A level of trust associated with a network node can be determined and/or modified based on the data packets the network node accepts and/or transmits, the network paths traversed by the accepted data packets, and traversed by the transmitted packets.

Returning to FIG. 1, in block 106 routing information is determined based on the level of trust. Accordingly, a system for routing a data packet based on geospatial information includes means for determining routing information based on the level of trust. For example, as illustrated in FIG. 2, the routing engine component 208 is configured for determining routing information based on the level of trust.

The routing engine 208 can be configured for evaluating a policy and/or to maintain a routing table. The maintaining of the routing table can be based on a routing metric based on a level of trust. When the routing engine 208 is configured for evaluating the policy, the policy can be based on a level of trust provided by the general processing unit 206.

In another aspect, determining routing information includes performing a routing table operation on a routing table based on the determined level of trust. For example, the routing engine component 208 can be configured for performing a routing table operation on a routing table based on the determined level of trust for determining routing information. A routing table operation can include a routing table lookup. Further, a routing table operation can include any operation for maintaining the routing table, such as updating the routing table. When the routing engine 208 is configured for maintaining a routing table, the structure of the routing table and/or an associated lookup operation is based on a level of trust. In such an aspect, the level of trust can be expressed in a metric. Both the policy and the routing table can include and/or generate routing information.

In another aspect, determining routing information includes performing a routing policy operation on a routing policy based on the determined level of trust. For example, the routing engine component 208 can be configured for performing a routing policy operation on a routing policy based on the determined level of trust for determining routing information. A routing policy operation can include an evaluation of the routing policy. A policy can be specified including a level of trust or a condition based on a level of trust. As discussed above, a policy can be evaluated based on a level of trust received as input for the policy evaluation. Alternatively or additionally, a policy can generate a level of trust as a result of evaluating the policy. Further, a policy can generate routing information including a subnet identifier, a label, and/or a network interface address of a network node in a network path. A routing table can be generated and/or maintained based on a metric expressing a level of trust. A routing table includes routing information. A lookup to the routing table can return routing information including a network path specification, a subnet identifier, a network and/or address of next hop network node.

According to an aspect, the receiving network node 204 can include additional components for enhancing its operation. Each line card of the receiving network node 204, including the first line card 302 and the second line card 214, can include a routing engine agent (REA). A REA can be provided for distributing the operation of the routing engine 208, offloading the work of the routing engine 208, and reducing traffic flow between the line cards and the general processing unit 206. A REA can operate as a cache maintaining a portion of the routing table maintained by the routing engine 208 and performing lookups locally in the including line card. In FIG. 3, a first REA 308 is illustrated in the first line card 302 and a second REA 318 is illustrated n the second line card 214.

As discussed above, the routing table operation can include an operation that updates the routing table based on a level of trust metric associated with a network node and an associated geospatial region. The routing information included in and provided by the routing table is based on a level of trust for updating the routing table. Trust information for identifying the level of trust metric can be user provided and/or can be provided by another network node as described above. The updating operation can be performed by the routing engine 208.

The type of update operation performed on the routing table depends on the routing protocol(s) supported by the receiving network node 204. The update operation can be performed in accordance with at least one of a link-state protocol, a distance vector protocol, a path vector protocol, and a label switching protocol. In a link-state protocol, a level of trust metric associated with a network node in a next hop in a network path can be provided. For example, a trust metric can be included in a type of service (TOS) field provided in a link-state advertisement (LSA) supported by the OSPF protocol. In a distance-vector routing protocol, a level of trust can be provided as a “distance” metric. For example, a level of trust metric can be included in a metric field supported by the RIP protocol (the metric field in RIP messages is currently used to specify a hop count). In a path vector protocol, a level of trust can be provided as a metric associated with a network path to a network node. The BGP protocol supports primarily policy-based routing discussed above, but can be extended to include a field for transmitting and receiving a level of trust indicator and/or a level of trust metric as can other protocols for supported policy-based routing.

Returning to FIG. 1, in block 108 a network interface of the receiving network node is identified for transmitting the data packet via a destination network path based on the routing information. Accordingly, a system for routing a data packet based on geospatial information includes means for identifying a network interface of the receiving network node for transmitting the data packet via a destination network path based on the routing information. For example, as illustrated in FIG. 2, a forwarding engine component 210 is configured for identifying a network interface of the receiving network node for transmitting the data packet via a destination network path based on the routing information.

In FIG. 2, the first network interface 202 can provide packet information, such as the network address of the destination host, to the forwarding engine 210. The forwarding engine 210 can receive the routing information provided by the routing engine 208. The forwarding engine 210 can identify a network interface for transmitting the data packet via destination network path based on the routing information and network information associated with each network interface included in the receiving network node 204.

According to an aspect, identifying the network interface includes performing a routing policy operation on a routing policy based on the determined level of trust. For example, the forwarding engine component 210 can be configured for performing a routing policy operation on a routing policy based on the determined level of trust for identifying the network interface. As discussed above, the routing policy operation on a routing policy can include an evaluation of the routing policy. As such, the forwarding engine 210 can be configured for identifying the network interface for transmitting the data packet based on an evaluation of a policy based on a level of trust. The forwarding engine 210 can retrieve a routing policy from the routing engine 208 for evaluation. The policy can be retrieved based on any information in the packet, a network path associated with the packet, a network node included in the network path associated with the packet, geospatial information, a level of trust indicator, and other data as required for required operation of the network 400 and or the receiving network node 204.

The routing policy is evaluated based on a level of trust as described above. Trust information for identifying the level of trust can be from another network node in the network 400 and/or received via user configuration. As discussed above, trust information can be included in and/or along with the packet information. The forwarding engine 210 can evaluate the policy based on the level of trust determined based on the trust information. Alternatively, the routing engine 208 can evaluate the policy based on the packet information provided by the forwarding engine 210.

In another aspect, identifying the network interface can include performing a routing table operation on a routing table based on the determined level of trust. For example, the forwarding engine component 210 can be configured for performing a routing table operation on a routing table based on the determined level of trust for identifying the network interface. As discussed above, a routing table operation on a routing table can include a routing table lookup. The forwarding engine 210 can be configured for identifying a network interface for transmitting the data packet over a destination network path by performing a lookup operation on a lookup table. For example, the forwarding engine 210 can provide packet information such as the network address of the destination host 410 to the routing engine 208 for performing a lookup in a routing table maintained by the routing engine 208. The routing table structure and/or the lookup operation can be based on the trust information described above. The lookup results can be returned to the forwarding engine 210.

Based on the results of the policy evaluation and/or the results of the lookup operation, the forwarding engine identifies a network interface of the receiving network node 204 for transmitting the data packet. According to an aspect, the evaluation of the policy can include determining a threshold condition based on a level of trust associated with the network node and an associated geospatial region. For example, the forwarding engine component 210 can be configured for evaluating a threshold condition based on the level of trust associated with the portion of the network path and for identifying the network interface in response to evaluating the threshold condition.

The network node can be in a destination network path for transmitting the data packet. The forwarding engine 210 can, in response to evaluating the policy, determine whether the threshold is met. When the determination indicates the threshold is met, the forwarding engine 210 can identify a network interface for transmitting the data packet via the destination path. The forwarding engine 210 can identify a network address of a next hop node in the destination network path as a result of the policy evaluation. The address of the next hop node can include a subnet identifier that can be compared to a subnet identifier provided by a line card including a network interface. A match of the subnet identifiers identifies, for example, a network interface 212 included in the second line card 214 for transmitting the data packet to the destination host 410, illustrated in FIG. 4.

Alternatively or additionally, the network node can be a network node in a network path traversed by the data packet, such as the first network node A 406. The forwarding engine 210 can, in response to evaluating the policy, determine whether the threshold is met. When the determination indicates the threshold is met, the forwarding engine 210 can identify a network interface for transmitting the data packet via the destination path. The forwarding engine 210 can identify a network address of network node in the destination network path as a result of the policy evaluation. The address of the network node can include a subnet identifier that can be compared to a subnet identifier provided by a line card including a network interface. A match of the subnet identifiers identifies a network interface 212 included in a second line card 214 for transmitting the data packet to the destination host 410.

In the network 400, the second network node A 416 can be the next network node for receiving the data packet over the destination network path. Alternatively, the second network node A 416 can be network node in a network path to the destination host from the next network node to the destination host 410. In either case, the second network node A 416, as well as each network node in the second network path A 414, is associated with the data packet when the data packet is to be routed over the second network path 414 to the destination host 410.

As discussed above, more than one destination path can exist in a network for transmitting a data packet to a destination host. A receiving network node can include one or more network interfaces each for transmitting a data packet via one or more of a plurality of destination paths. The forwarding engine 210 can be configured for identifying a network interface included in the more than one network interface for transmitting the data packet via an optimal destination path. Optimal can be defined by a policy evaluated and/or a lookup operation on a particular routing table.

Each line card of the receiving node (router) 204, including the first line card 302 and the second line card 214, can include a forwarding engine agent (FEA). An FEA can be provided for interoperating with an associated REA (described above) as the forwarding engine 210 interoperates with the routing engine 208 for identifying a network interface for transmitting the packet. An FEA provides distributed operation of the forwarding engine 210 by offloading the work of the forwarding engine 210 and reducing traffic flow between the line cards and the general processing unit 206. An FEA can operate, as indicated above, with an REA for evaluating a policy and/or performing a routing table lookup in a line card of a received data packet. If a network interface for transmitting the packet is identified, the general processing unit 206 and its components need not be involved in identifying the network interface. The line card, in these cases, plays the role of a general processing unit hosting its own forwarding engine agent (FEA) and routing engine agent (REA). In FIG. 3, a first FEA 310 is illustrated in the first line card 302 and a second FEA 320 is illustrated in the second line card 214.

Returning to FIG. 1, in block 110 the data packet is routed via the identified network interface. Accordingly, a system for routing a data packet based on geospatial information includes means for routing the data packet via the identified network interface. For example, as illustrated in FIG. 2, a line card component 214 is configured for routing the data packet via the identified network interface.

The forwarding engine 210 can configure a communications medium 216 included in the receiving network node 204 for delivering the data packet from the receiving first network interface 202 to the line card component 214 for routing the data packet via the identified second network interface 212. The communications medium 216 can be any suitable media including a bus, and a switch interconnect unit 316 as illustrated in FIG. 3.

In FIG. 3, the forwarding engine 210 can configure the switch interconnect unit 316 to provide a communication channel from the first line card 302 to the second line card 214. Each line can include a switch interface (SI) for writing packet data to a channel configured in the switch interconnect unit 316 and/or for reading packet data from a channel. An FEA, such as the first FEA 310, can identify the network interface, the second network interface 212, for transmitting the data packet. A first SI 312 of the first line card 302 can setup a channel for communicating the data packet to a second SI 322 of the second line card. The second SI 322 can read the packet data and provide the packet data to the identified second network interface 212 for transmitting. An FEA optionally interoperating with an associated REA can be configured for modifying the transmission of the data packet based on a policy and/or routing table information stored in the including line card. For example, the second FEA 320 interoperating with the second REA 318 can alter a network path including a next hop to be traversed by the network packet prior to providing the data packet to the second network interface 212 for transmitting. The second FEA 320 can identify yet another network interface for transmitting the data packet or can interoperate with the forwarding engine 210 to identify another network interface or confirm the network interface identified by the first FEA 310.

The data packet has a packet type. Packet types that can be supported include unicast data packets, broadcast data packets, and multicast data packets associated with one or more destination hosts. One or more network interfaces can be identified for transmitting the data packet via one or more destination paths to one or more destination hosts.

In another aspect, routing the data packet includes discarding the data packet. A receiving device can discard a data packet by providing it to a line card with a null network interface. In another aspect, routing the data packet includes determining a position in a queue associated with the identified network interface based on the level of trust. A network interface can have one or more queues for queuing data packets for transmitting in an orderly fashion. A priority can be associated with a data packet for determining a queue and/or a position in a queue for placing the data packet for transmitting by the network interface. The forwarding engine 210 can be configured for assigning a priority to a data packet based on the level of trust determined for identifying the network interface.

For example, when a level of trust is relatively low, a forwarding engine 210 can apply a policy that assigns a relatively high priority to the data packet determined to include sensitive data on the presumption that the faster the packet reaches its destination the less opportunity there will be for tampering or otherwise interfering with the data packet. Alternatively, when a level of trust determined for identifying the network interface is relatively high, a forwarding engine 210 can apply a policy that assigns a relatively low priority to the data packet determined to have data of relatively low sensitivity on the presumption that the likelihood of tampering is low regardless of the time the data in the packet is on the relatively high trust portion of the network path to the destination.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein can be embodied in executable instructions stored in a computer readable medium for use by or in connection with an instruction execution machine, system, apparatus, or device, such as a computer-based or processor-containing machine, system, apparatus, or device. As used here, a “computer readable medium” can include one or more of any suitable media for storing the executable instructions of a computer program in one or more of an electronic, magnetic, optical, electromagnetic, and infrared form, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein can be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for routing a data packet based on geospatial information, the method comprising:
receiving, at a receiving network node, a data packet transmitted by a source host for transmitting to a destination host;
determining a level of trust for a portion of a network path from the source host to the destination host, the portion of the network path having a geospatial region, the level of trust based on trust information associated with the geospatial region;
determining routing information based on the level of trust;
identifying a network interface of the receiving network node for transmitting the data packet via a destination network path based on the routing information; and
routing the data packet via the identified network interface.

2. The method of claim 1 wherein determining a level of trust includes receiving the trust information for determining the level of trust.

3. The method of claim 2 wherein the received trust information is included in at least one of the received data packet, a routing protocol message, and configuration data.

4. The method of claim 1 wherein the trust information includes geospatial information identifying the geospatial region of the portion of the network path.

5. The method of claim 1 wherein the portion of the network path from the source host to the destination host includes a path network node, wherein the level of trust is based on a geospatial region associated with the path network node.

6. The method of claim 1 wherein determining routing information includes performing a routing table operation on a routing table based on the determined level of trust.

7. The method of claim 1 wherein determining routing information includes performing a routing policy operation on a routing policy based on the determined level of trust.

8. The method of claim 1 wherein identifying the network interface includes performing a routing table operation on a routing table based on the determined level of trust.

9. The method of claim 1 wherein identifying the network interface includes performing a routing policy operation on a routing policy based on the trust information.

10. The method of claim 1 further comprising evaluating a threshold condition based on the level of trust associated with the portion of the network path; wherein identifying the network interface occurs in response to evaluating the threshold condition.

11. The method of claim 1 wherein routing the data packet includes discarding the data packet.

12. The method of claim 1 wherein routing the data packet includes determining a position in a queue associated with the identified network interface based on the level of trust.

13. A system for routing a data packet based on geospatial information, the system comprising:
means for receiving, at a receiving network node, a data packet transmitted by a source host for transmitting to a destination host;
means for determining a level of trust for a portion of a network path from the source host to the destination host, the portion of the network path having a geospatial region, the level of trust based on trust information associated with the geospatial region;
means for determining routing information based on the level of trust;
means for identifying a network interface of the receiving network node for transmitting the data packet via a destination network path based on the routing information; and
means for routing the data packet via the identified network interface.

14. A system for routing a data packet based on geospatial information, the system comprising:
a network interface component configured for receiving, at a receiving network node, a data packet transmitted by a source host for transmitting to a destination host;
a general processing unit component configured for determining a level of trust for a portion of a network path from the source host to the destination host, the portion of the network path having a geospatial region, the level of trust based on trust information associated with the geospatial region;
a routing engine component configured for determining routing information based on the level of trust;
a forwarding engine component configured for identifying a network interface of the receiving network node for transmitting the data packet via a destination network path based on the routing information; and
a line card component configured for routing the data packet via the identified network interface.

15. The system of claim 14 wherein the general processing unit component is configured receiving the trust information for determining the level of trust.

16. The system of claim 15 wherein the trust information is included in the received data packet.

17. The system of claim 15 wherein the trust information includes geospatial information identifying the geospatial region of the portion of the network path.

18. The system of claim 14 wherein the portion of the network path from the source host to the destination host includes a path network node, wherein the general processing unit component is configured for determining the level of trust based on a geospatial region associated with the path network node.

19. The system of claim 14 wherein the routing engine component is configured for performing a routing table operation on a routing table based on the determined level of trust for determining routing information.

20. The system of claim 14 wherein the routing engine component is configured for performing a routing policy operation on a routing policy based on the determined level of trust for determining routing information.

21. The system of claim 14 wherein the forwarding engine component is configured for performing a routing table operation on a routing table based on the determined level of trust for identifying the network interface.

22. The system of claim 14 wherein the forwarding engine component is configured for performing a routing policy operation on a routing policy based on the determined level of trust for identifying the network interface.

23. The system of claim 14 wherein the forwarding engine component is configured for evaluating a threshold condition based on the level of trust associated with the portion of the network path and for identifying the network interface in response to evaluating the threshold condition.

24. The system of claim 14 wherein the line card component is configured for determining a position in a queue associated with the identified network interface based on the level of trust.

25. A computer readable medium embodying a computer program, executable by a machine, for routing a data packet based on geospatial information, the computer program comprising executable instructions for:
receiving, at a receiving network node, a data packet transmitted by a source host for transmitting to a destination host;
determining a level of trust for a portion of a network path from the source host to the destination host, the portion of the network path having a geospatial region, the level of trust based on trust information associated with the geospatial region;
determining routing information based on the level of trust;
identifying a network interface of the receiving network node for transmitting the data packet via a destination network path based on the routing information; and
routing the data packet via the identified network interface.
